(19) United States
(12) Patent Application Publication
(10) Pub. No.: US 2025/0361121 A1
(43) Pub. Date: Nov. 27, 2025

(54) ADJUSTABLE-TILT SPREADER BAR

(71) Applicant: Innovatech Systems, LLC, Kanarraville, UT (US)

(72) Inventors: James Barlow, Colorado City, AZ (US); James Harker, Colorado City, AZ (US)

(73) Assignee: Innovatech Systems, LLC, Kanarraville, UT (US)

(21) Appl. No.: 19/217,213

(22) Filed: May 23, 2025

Related U.S. Application Data
(60) Provisional application No. 63/651,192, filed on May 23, 2024.
(60) Provisional application No. 63/676,691, filed on Jul. 29, 2024.

(51) Int. Cl. B66C 1/12

(52) U.S. Cl. CPC B66C 1/12

(57) ABSTRACT

A spreader bar that is capable of tilting from side-to-side is disclosed. The spreader features a frame, a first linear actuator, a second linear actuator, at least one motor for actuating the first and second actuator, a power source, and a plurality of cable couplers. The linear actuators may be hydraulically actuated or electrically driven (e.g., screw driven), and are positioned to tilt the spreader bar for hoisting objects that are unlevel or uneven, which includes wall panels with varying attachment points at different heights. In some versions, the spreader bar features a microcontroller for controlling the linear actuators and a wireless transceiver for transmitting and receiving data to and from a user positioned at a safe distance.

### CROSS-REFERENCE TO RELATED APPLICATIONS

This application claims the benefit of U.S. Provisional Application Ser. No. 63/651,192, filed on May 23, 2024, and further claims the benefit of U.S. Provisional Application Ser. No. 63/676,691, filed on Jul. 29, 2024, both of which are incorporated herein by reference.

### TECHNICAL FIELD

The present disclosure relates to spreader bars in building construction. More particularly, the present disclosure relates to an adjustable-tilt spreader bar.

### BACKGROUND

In the construction industry, spreader bars are essential tools used for lifting and moving heavy loads. These devices are particularly useful for hoisting large wall panels, which can be made from materials such as concrete, metal, and other heavy substances. The primary function of a spreader bar is to distribute the load evenly across multiple lifting points, ensuring stability and balance during the lifting process. However, several challenges arise when using spreader bars, particularly when dealing with wall panels or other heavy objects that are not initially positioned in an optimal manner for lifting.

One common scenario that illustrates these challenges involves the attachment of a spreader bar to a wall panel positioned horizontally along its longitudinal axis, yet upright. In such cases, the cables or slings used to secure the spreader bar to the panel are typically of the same length. This uniformity in cable length necessitates lowering the spreader bar sufficiently to reach the side of the panel that is closest to the ground. Consequently, the cables attached to points higher up on the panel become slack or excess in length.

This situation creates several problems. First, the slack cables pose safety hazards, as they can become entangled or create tripping risks for workers on the construction site. Second, the uneven lifting process that results from the initial tension in the lowest cable can lead to instability. As the bottom taut cable begins to lift the panel, the upper cables, which are not yet under tension, do not contribute to the lifting process. This uneven distribution of lifting force can cause the panel to tilt or swing unpredictably, increasing the risk of damage to the panel and posing significant safety risks to nearby personnel.

Moreover, the need to control the angle or tilt of the spreader bar becomes critical when dealing with unlevel or uneven objects, or objects with different weight distributions. Traditional spreader bars may not provide the necessary adjustments to compensate for these variations, leading to further complications in the lifting process. The inability to precisely control the tilt or angle of the spreader bar can result in inefficient and hazardous lifting operations, thereby necessitating the development of improved solutions to address these issues.

In summary, while spreader bars are indispensable for lifting and moving heavy loads in construction, their effective use is hampered by challenges related to uneven cable tension, the need for precise angle control, and the safe handling of objects with varying weight distributions. Addressing these challenges is crucial for enhancing the safety, efficiency, and reliability of lifting operations in the construction industry. Accordingly, the present disclosure seeks to solve these and other problems.

### SUMMARY OF EXAMPLE EMBODIMENTS

In some embodiments, a spreader bar comprises a frame, a first linear actuator, a second linear actuator, at least one motor for actuating the first and second actuator, a power source, a control unit, and a plurality of cable couplers.

In some embodiments, the linear actuators are hydraulically actuated. In some embodiments, the linear actuators are electrically driven (e.g., screw driven). In some embodiments, the control unit of the spreader bar comprises AC or DC drives and AC or DC motors. In some embodiments, the control unit comprises a microcontroller for controlling the linear actuators and a wireless transceiver for transmitting and receiving data to and from a user positioned at a safe distance.

### BRIEF DESCRIPTION OF THE DRAWINGS

FIG. 1 illustrates a front perspective view of a spreader bar in a first, tilted configuration lifting a panel from an uneven position;

FIG. 2 illustrates a front elevation view of a spreader bar in a second, level position, with the panel lifted and leveled;

FIG. 3 illustrates a top, front perspective view of a spreader bar in a second, leveled position;

FIG. 4 illustrates a front perspective view of a spreader bar in a first, tilted position;

FIG. 5 illustrates a front exploded view of a spreader bar; and

FIG. 6 illustrates a rear, detailed perspective view of a spreader bar with a frame removed.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, while spreader bars are indispensable for lifting and moving heavy loads in construction, their effective use is hampered by challenges related to uneven cable tension, the need for precise angle control, and the safe handling of objects with varying weight distributions. Accordingly, there is a need to control the angle, or tilt, of the spreader bar, to compensate for unlevel, uneven, or objects having different weight distributions. The spreader bar disclosed herein solves these and other problems.

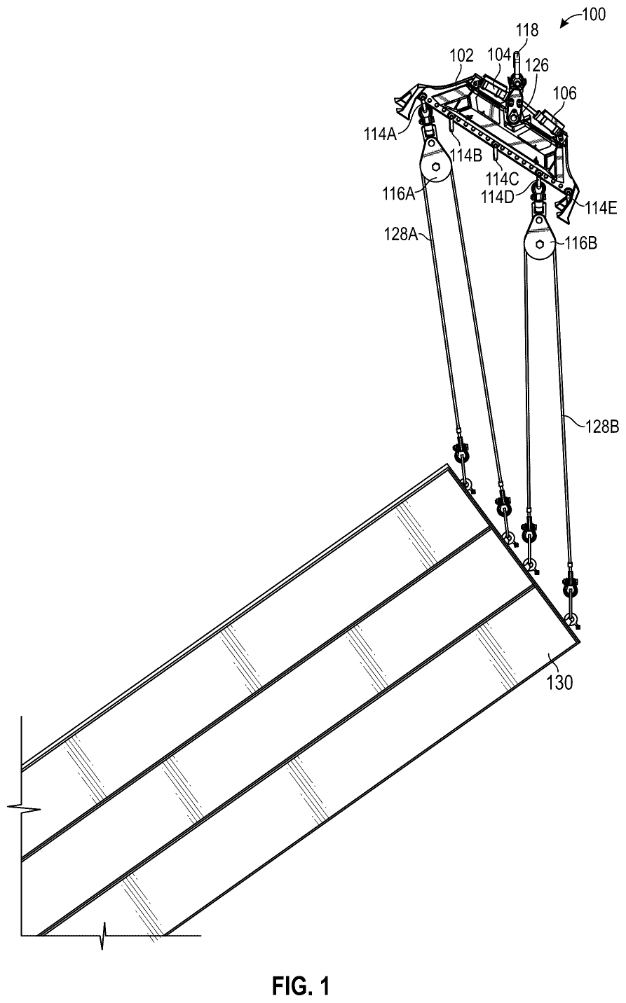

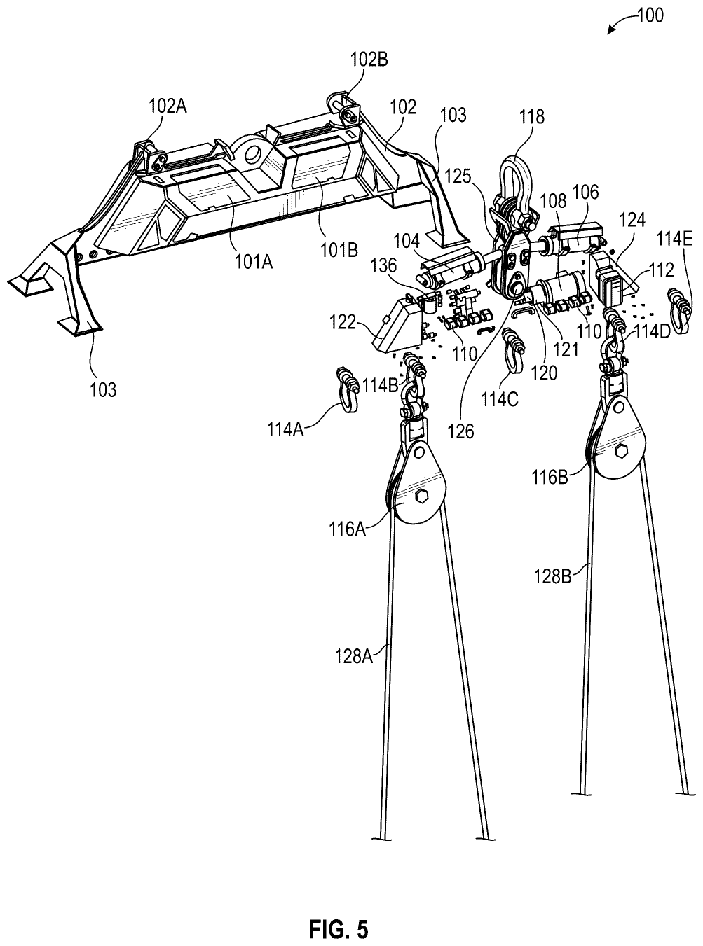

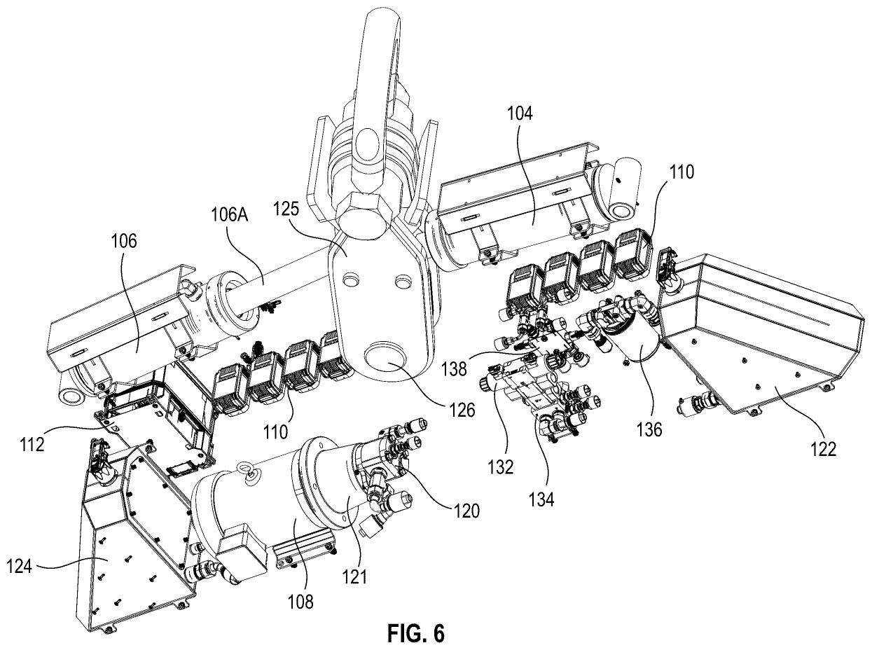

Referring to FIGS. 1-5, in some embodiments, a spreader bar 100 comprises a frame 102, a first linear actuator 104, a second linear actuator 106, at least one motor 108 (FIGS. 5-6) for actuating the first and second actuators 104, 106, a power source (e.g., batteries 110), a control unit 112 (e.g., one or more AC or DC drives, microcontroller, etc.) for controlling the voltage and/or frequency of the electrical supply to the one or more motors 108, and to thereby control the speed, torque, and/or direction of the one or more motors 108, and a plurality of cable couplers 114A-E. A respective pulley 116A-B may be coupled to a respective cable coupler 114A-E, as selected by a user and depending on the width of the panel 130 being hoisted. The cable couplers 114A-E may be positionable along a base 102C of the frame 102, such as by coupling to a respective aperture 105 in the base 102C. A crane coupler 118 is positioned on the top of the frame 102 to allow the spreader bar 100 to be lifted by a crane or other machine.

The plurality of batteries 110 ensure sufficient power for the control unit 112 and the motor 108. The batteries 110 may be removably chargeable and/or replaceable. In some embodiments, the spreader bar comprises a battery management system (BMS), wherein the batteries 110 are coupled to the BMS, which is configured to monitor the state of charge of the one or more batteries 110, and which may charge the batteries 110 accordingly. For example, the BMS may be wired to include a charging port at a convenient location on the spreader bar 100. In this manner, when the spreader bar 100 is not in use, a user may couple grid power to the BMS via the charging port, thereby allowing the BMS to charge the respective batteries 110.

Referring back to FIG. 1, it will be understood that the spreader bar 100 is capable of tilting to a user-desired direction and angle via the linear actuators 104, 106. For example, as shown, the first linear actuator 104 is compressed while the second linear actuator 106 is extended, resulting in the frame 102 tilting on pivot rod 126. This is beneficial when, as shown, the lifting cables 128A-B need to be positioned at different vertical heights, such as to couple to a wall panel 130 that is being hoisted upwardly along a narrow end that was resting vertically. Due to the tilted position of the frame 102, the second lifting cable 128B extends farther (i.e., closer to the ground) for coupling to the wall panel 130 while the first lifting cable 128A remains higher from the ground. In other words, the first cable 128A has a different height than the second lifting cable 128B. This allows all cables 128A-B to be taut, or substantially taut, overcoming the prior art. As discussed earlier, because spreader bars in the art do not tilt, they must be lowered sufficiently so that cables may reach the connection points closest to the ground. However, this results in the cables being coupled to higher points on the panel being slack, rather than taut, which creates dangers.

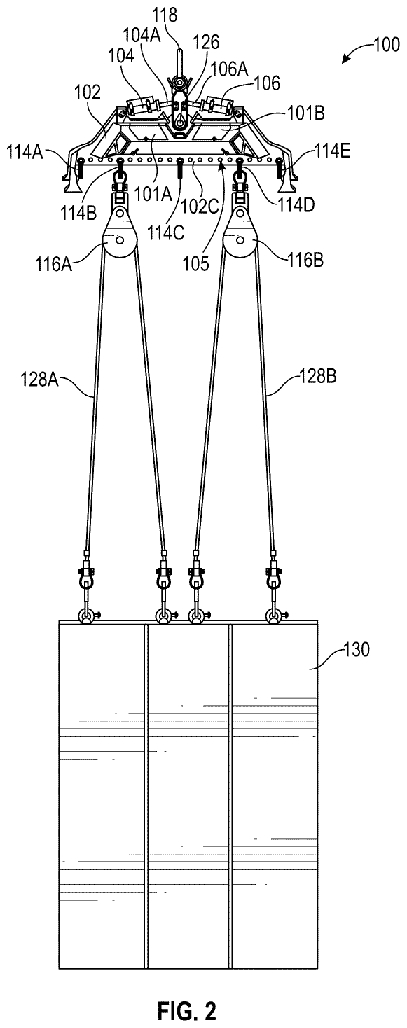

Referring to FIG. 2, as the wall panel 130 is hoisted, the user may actuate the linear actuators 104, 106 so as to level the frame 102 and thereby level the wall panel 130 (or other hoisted object). As shown, the linear actuators 104, 106 are in equal positions to one another (i.e., each piston in the same position relative to the cylinder), thereby leveling the frame 102. By using the control unit 112 (which may comprise a wireless transceiver) and batteries 110, there are no additional exposed power cables or communication cables. Instead, a user may stand at a safe distance while controlling the position of the wall panel 130 via a remote or smartphone/tablet (or other connected device) to control the state of the linear actuators 104, 106 via the control unit 112.

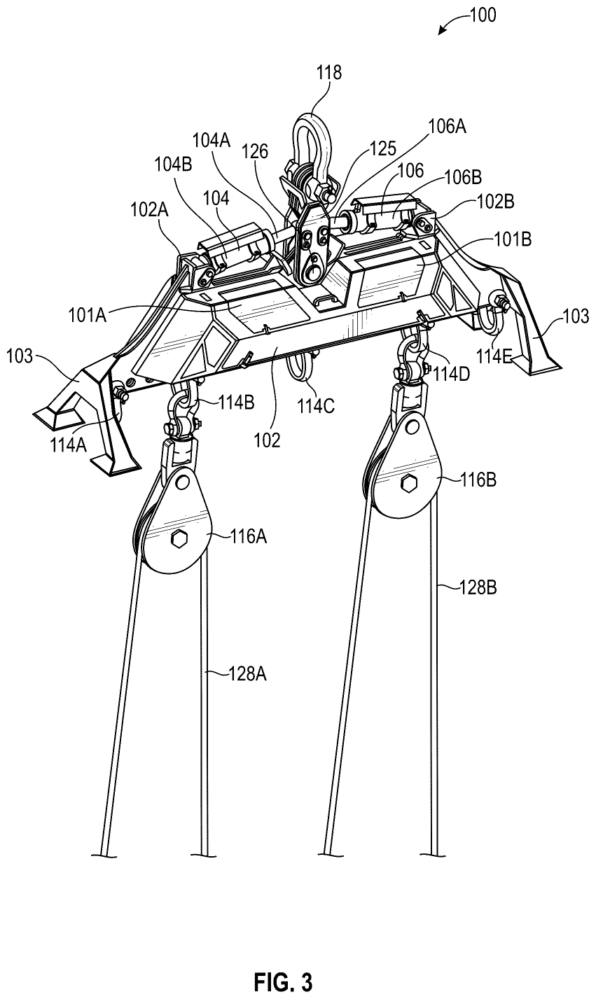

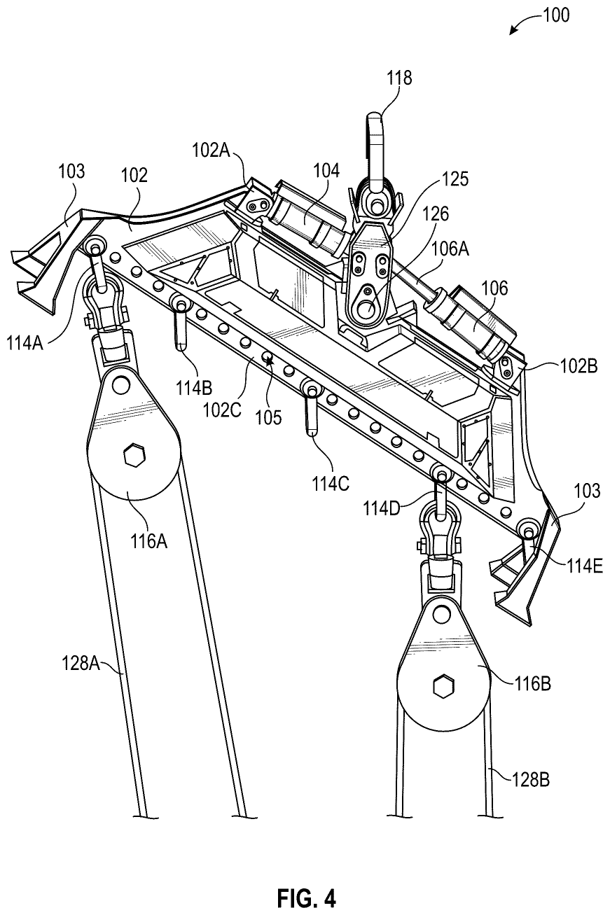

FIGS. 3-4 illustrate the spreader bar 100 in more detail. As shown, the frame 102 is coupled to a top bracket 125 via the pivot rod 126. The crane coupler 118 is pivotably coupled to the top of the top bracket 125. Additionally, the piston 104A of the first linear actuator 104 is coupled to the top bracket 125, with the cylinder 104B coupled to a first side 102A of the frame 102. Likewise, the piston 106A of the second linear actuator 106 is coupled to the top bracket 125, with the cylinder 104B coupled to a second side 102B of the frame 102. As shown in FIG. 3, when both linear actuators 104, 106 have the same position (i.e., pistons 104A, 106A are equally extended), the frame 102 is level, resulting in the lifting cables 128A-B being equally distant to the ground. It will be appreciated that while specific ends of the linear actuators 104, 106 are described and shown as being coupled to specific components in specific orientations, they may be reversed without departing herefrom.

As shown in FIG. 4, when the linear actuators 104, 106 have differing positions (i.e., the respective pistons are extended at differing lengths), the frame 102 is tilted. For example, when the piston 106A of the second linear actuator 106 is fully extended and the first piston 104A is fully retracted, the frame 102 is tilted in a first direction. This is due to the second linear actuator 106 being interposed between the second side 102B of the frame 102 and the top bracket 125. When the piston 106A extends, it creates a force that seeks to separate the top bracket 125 from the second side 102B of the frame 102. This causes the frame 102 to then pivot on the pivot rod 126, resulting in the second side 102B of the frame 102 and the second pulley 116B both having a lower elevation than the first side 102A and first pulley 116A. This allows the second lifting cable 128B to have a shorter distance from the ground than the first lifting cable 128A. As appreciated, the pulleys 116A-B are pivotably coupled to the cable couplers 114A-E, and/or the cable couplers 114A-E are each pivotably coupled to the frame 102, allowing the pulleys 116A-B to reposition as the frame 102 tilts from side to side. If the piston 104A of the first linear actuator 104 is retracted, the tilt angle is increased.

In some embodiments, the linear actuators 104, 106 are hydraulically actuated. For example, referring to FIGS. 5-6, the motor 108 drives a hydraulic pump 120, which may include a coupler 121 interposed therebetween, pressurizing hydraulic fluid from one or more hydraulic tanks 122, 124, which then drives a respective linear actuator 104, 106. However, while shown as being hydraulicly driven, it will be appreciated that in some embodiments, the linear actuators 104, 106 are electrically driven (e.g., screw driven). As appreciated, the frame 102 forms an enclosure within which the hydraulic components and power components are housed. The frame 102 may comprise access panels 101A-B, which may be hinged or removable, to allow a user to access the internal components (e.g., batteries 110, control unit 112, hydraulic components, etc.). The frame 102 may further comprise legs 103 to support the frame 102 when not in use.

As previously discussed, when the first linear actuator 104 extends and the second linear actuator 106 contracts, the spreader bar 100 tilts in a first direction. When the first linear actuator 104 contracts and the second linear actuator 106 extends, the spreader bar 100 tilts in a second direction. Referring to FIG. 6, this dual control of both linear actuators 104, 106 via a single pump 120 may be accomplished via a proportional directional control valve 132 coupled to a hydraulic manifold 134, which may be controlled via the one or more control unit 112 or by using a current control signal or by an electronic control unit (ECU) coupled to the proportional directional control valve 132. The spreader bar 100 may further comprise a hydraulic fluid filter 136, a dual crossover hydraulic relief cushion valve 138, and other components known in the art of hydraulics. Hydraulic tubing and electrical wires are not shown in the illustrations for ease in viewing componentry, but it will be understood that such tubing and wiring is included herein.

To control the motor 108, a control unit 112 may be utilized. The control unit 112 may comprise AC or DC drives and/or microcontrollers, and may further comprise or be coupled to a wireless transceiver for transmitting and receiving data to and from a user positioned at a safe distance. The user may send signals from a remote (e.g., IR, Bluetooth®, Wi-Fi, etc.) or other handheld electronic device (e.g., smartphone, tablet) that is capable of transmitting signals to the transceiver, with the control unit 112 then controlling the motor 108 and pump 120. In some embodiments, the control unit 112 may comprise, or be otherwise coupled to, a control module comprising a microcontroller (or other processor) and a wireless transceiver, wherein the control module is configured to send and receive data to and from a user, respectively, via the the wireless transceiver and the user may operate the control unit 112 via the microcontroller of the control module. The control unit 112 and/or control module may be configured to control the hydraulic components, such as the proportional directional control valve 132 to thereby control the direction that the spreader bar 100 tilts. It will also be appreciated that, in some embodiments, each linear actuator 104, 106 may be controlled independently via respective motors and/or pumps. In other words, each linear actuator 104, 106 may have its own motor and/or pump.

The control unit 112, or control module coupled thereto, may be configured to report the status of various components to a user, such as on/off status of the motor 108, RPM of the motor 108, direction of the motor 108, temperature of the motor 108 and/or the control unit 112 and/or batteries 110, the state of charge of the batteries 110, or any other metric or information useful to a user. It will be appreciated that one or more corresponding sensors (e.g., temperature sensor, current sensor, etc.) may be used to gather data from the various components and to report to the control unit 112 and/or control module. The control unit 112 and/or control module may then transmit this data to the user. The control unit 112 and/or control module is also configured to receive input from a user from a wireless connected device (e.g., remote, smartphone, tablet, etc.), such as to turn on/off the motor 108, control the direction of the tilt (such as via the proportional directional control valve 132 and other associated components), emergency shutdown, or other details.

In some embodiments, the control unit 112 and/or control module may be programmed to activate or deactivate components, such as motor 108, in response to a triggering event, such as user input (e.g., emergency shutdown) or detecting a sensor reading that meets or exceeds a predetermined threshold or is outside of a predefined acceptable range (e.g., motor 108 temperature above a predetermined safe operating temperature).

Computing systems have been described herein, such as control unit 112 and/or control module. In its most basic configuration, a computing system includes a processor and a computer-readable hardware storage medium that may hold computer-executable instructions for execution by the processor. The processor and the computer-readable medium may be combined, such as by using a microcontroller. A computing system may also include (or are in wired or wireless communication with) a user interface, such as a controller with one or more input triggers (e.g., buttons, touch screen(s), etc.). In some implementations, the computing system(s) is (are) in communication (via a wired or wireless connection) with one or more user interfaces for communicating information to a user and/or receiving user input. The user interface may be a wireless remote (e.g., Bluetooth®, Wi-Fi®, satellite, infrared, etc.) or may be a user's device, such as a smartphone or tablet. When utilizing a user's device, application software may be programmed and deployed to pair and/or interface with the control unit 112 and/or control module or other computing system of the spreader bar 100.

Remote systems/devices may be configured to perform any of the processing described with regard to the control unit 112 and/or control module or other computing system. By way of example, a remote system may include an administrative system that defines operation constraints for the spreader bar 100, receives sensor readings from the sensors (e.g., current sensor, temperature sensor, etc.), and/or issues commands to selectively deactivate the motor/AC drives that are in communication with the computing system.

Those skilled in the art will also appreciate that the disclosed methods may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

In some embodiments, the computing system (e.g., control unit 112 and/or control module) includes computer-executable instructions (e.g., stored on storage) that enable the computing system (e.g., by one or more processors executing the computer-executable instructions) to selectively activate or deactivate any portion of the spreader bar 100, such as the control unit 112, the motor 108, etc. In some instances, the computing system selectively deactivates at least one component of the spreader bar 100 in response to a triggering event. In some instances, the triggering event is detecting that a sensor reading (e.g., current sensor, temperature sensor, etc.) of one or more sensors has met or exceeded a predetermined threshold value or is outside of a predetermined acceptable range.

For example, the computing system may selectively deactivate a component of the spreader bar 100 in response to determining that the temperature of the motor 108, the temperature of the control unit 112, or the temperature of the hydraulic fluid has exceeded a predefined safe operation temperature. In other instances, the system may selectively deactivate a component of the spreader bar 100 in response to determining that the RPM of the motor 108 is too high, or the hydraulic pressure has exceeded a predetermined threshold, such as those defined by the user or manufacturer of the component.

Furthermore, the computing system may cause sensor values detected by the various sensors (e.g., current sensor, temperature sensor, etc.) in communication with the computing system to be displayed on a user display or user interface (e.g., an I/O interface and/or a display of a remote system/device, smartphone, tablet, computer, etc.). For example, sensor readings may be displayed on a display of a user/administrator interface associated with the computing system. The computing system may display motor 108 status, RPMs, current, SOC of the batteries 110, temperature of the motor 108, among others. The input may include various input buttons (i.e., “AUTO”, “ON”, “OFF”) for triggering selective activation/deactivation of the motor 108 or other components. Displaying combinations of sensor readings to a user/administrator may make it easier for a user/administrator to ensure that the spreader bar 100 is operated with due care, so as to avoid damage caused by improper operation thereof.

In some embodiments, the control unit 112 and/or control module may be programmable, such as to allow a user to set the preferred angle of the spreader bar 100 by using a set position (e.g., tilted left, tilted right, etc.), to thereby effectuate quick and consistent hoisting of one panel 130 to the next.

It will be appreciated that the spreader bar 100 may comprise one or more sensors for detecting various states/conditions. For example, the sensors may monitor motor temperature, hydraulic pressure and temperature, battery charge state, current angle of the frame 102, or any other number of states/conditions. The control unit 112 (comprising a microcontroller or other controller/processor) may collect, process, and/or transmit the data from the sensors to a user via the transceiver. In some embodiments, the control unit 112 may be programmed to initiate one or more actions based upon a triggering event. For example, if the temperature exceeds a predetermined threshold, the control unit 112 may turn off the motor 108 and send a notification to the user to indicate the overheating status. A user may also pre-program positions for the frame 102, such as to return to a level position. In this way, once the wall panel 130 is sufficiently hoisted, a user may press a button on the remote/smart device to instruct the control unit 112 to level the frame 102 by actuating the linear actuators 104, 106 to mirror each other.

In one method of use, a user would lower the spreader bar 100 until the first lifting cable 128A reaches the highest coupling point on the wall panel 130. The user would then, using a remote or smart device, begin tilting the frame 102 by actuating the linear actuators 104, 106 until the second lifting cable 128B is sufficiently lowered so as to couple to the lowest point on the wall panel 130. As best shown in FIGS. 1 & 4, the angle may be accomplished by compressing the first linear actuator 104 while extending the second linear actuator 106. Once the lifting cables 128A-B are coupled to the wall panel 130, the crane may lift the spreader bar 100 via the crane coupler 118. Once sufficiently hoisted, the user may then actuate the first and second linear actuators 104, 106 until they have the same state (i.e., pistons extended the same), thereby leveling the wall panel 130, as shown in FIG. 2. As a result, the lifting cables 128A-B remain taut throughout the process, reducing or eliminating dangers and risks.

As previously discussed, while spreader bars are indispensable for lifting and moving heavy loads in construction, their effective use is hampered by challenges related to uneven cable tension, the need for precise angle control, and the safe handling of objects with varying weight distributions. As appreciated from the foregoing, the spreader bar 100 disclosed herein solves the need to control the angle, or tilt, of the spreader bar, to compensate for unlevel, uneven, or objects having different weight distributions, overcoming the prior art.

It will be appreciated that systems and methods according to certain embodiments of the present disclosure may include, incorporate, or otherwise comprise properties or features (e.g., components, members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A spreader bar for hoisting panels during construction, the spread bar comprising:
a frame;
a top bracket pivotably coupled to the frame;
a crane coupler coupled to the top bracket;
a first linear actuator coupled between the top bracket and the frame on a first side;
a second linear actuator coupled between the top bracket and the frame on a second side;
a motor configured to actuate the first and second linear actuators;
a plurality of pulleys coupled to the frame; and
a respective lifting cable coupled to each pulley.

2. The spreader bar of claim 1, wherein the top bracket is pivotably coupled to the frame via a pivot rod.

3. The spreader bar of claim 1, wherein the plurality of pulleys are each coupled to the frame via a respective cable coupler.

4. The spreader bar of claim 3, wherein each cable coupler is coupled to a respective aperture through a base of the frame.

5. The spreader bar of claim 1, further comprising a hydraulic pump coupled to the motor, and one or more hydraulic tanks coupled to the hydraulic pump.

6. The spreader bar of claim 5, further comprising a directional proportional control valve coupled to a hydraulic manifold.

7. The spreader bar of claim 5, further comprising a dual crossover hydraulic relief cushion valve.

8. The spreader bar of claim 5, further comprising one or more batteries for powering the motor.

9. The spreader bar of claim 5, further comprising a control unit configured to control the motor.

10. The spreader bar of claim 1, further comprising one or more batteries for powering the motor.

11. The spreader bar of claim 1, wherein the frame forms and enclosure and further comprises one or more access panels.

12. A spreader bar for hoisting panels during construction, the spreader bar comprising:
a frame, comprising:
one or more access panels,
a base, and
one or more legs
a top bracket pivotably coupled to the frame via a pivot rod;
a crane coupler coupled to the top bracket;
a first linear actuator coupled between the top bracket and a first side of the frame;
a second linear actuator coupled between the top bracket and a second side of the frame;
a motor coupled to a hydraulic pump, the hydraulic pump coupled to one or more hydraulic tanks comprising hydraulic fluid, wherein the hydraulic fluid selectively actuates the first linear actuator and second linear actuator;
a plurality of pulleys coupled to the base of the frame; and
a respective lifting cable coupled to each pulley.

13. The spreader bar of claim 12, wherein the plurality of pulleys are each coupled to the frame via a respective cable coupler.

14. The spreader bar of claim 13, wherein each cable coupler is coupled to a respective aperture through the base of the frame.

15. The spreader bar of claim 12, further comprising a directional proportional control valve coupled to a hydraulic manifold.

16. The spreader bar of claim 12, further comprising a dual crossover hydraulic relief cushion valve.

17. The spreader bar of claim 12, further comprising one or more batteries for powering the motor.

18. The spreader bar of claim 12, further comprising a control unit configured to control the motor.

19. A method of using a spreader bar for hoisting panels during construction, the method comprising:
tilting the spreader bar in a first direction by actuating a motor of the spreader bar, the motor extending at least one linear actuator, the at least one actuator forcing a frame of the spreader bar to tilt in the first direction;
coupling a first lifting cable to a first end of a panel to be hoisted, the first end proximal to the ground;
coupling a second lifting cable to a second end of the panel, the second end distal to the ground;
lifting the spreader bar with a crane; and
compressing the at least one actuator to level the frame of the spreader bar.

20. The method of claim 19, wherein the motor is wirelessly actuated.
